(19) United States
(12) Patent Application Publication
(10) Pub. No.: US 2025/0337013 A1
(43) Pub. Date: Oct. 30, 2025

(54) ELECTROLYTE SOLUTION FOR RECHARGEABLE LITHIUM BATTERY AND RECHARGEABLE LITHIUM BATTERY INCLUDING THE SAME

(71) Applicant: SAMSUNG SDI CO., LTD., Gyeonggi-do (KR)

(72) Inventors: Seungryong OH, Gyeonggi-do (KR); Dahyun KIM, Gyeonggi-do (KR); Sanghoon KIM, Gyeonggi-do (KR); Aeran KIM, Gyeonggi-do (KR); Jeongmin SHIN, Gyeonggi-do (KR); Olga TSAY, Gyeonggi-do (KR); Pavel SHATUNOV, Gyeonggi-do (KR); Myunghoon KIM, Gyeonggi-do (KR)

(73) Assignee: SAMSUNG SDI CO., LTD., Gyeonggi-do (KR)

(21) Appl. No.: 18/919,956

(22) Filed: Oct. 18, 2024

(30) Foreign Application Priority Data
Apr. 25, 2024 (KR) 10-2024-0055505

(51) Int. Cl. H01M 10/0567; H01M 4/02; H01M 4/525; H01M 4/583; H01M 10/0525; H01M 10/0568; H01M 10/0569

(52) U.S. Cl. CPC H01M 10/0567; H01M 4/525; H01M 4/583; H01M 10/0525; H01M 10/0568; H01M 10/0569; H01M 2004/027; H01M 2004/028

(57) ABSTRACT

The present disclosure relates to an electrolyte solution for a rechargeable lithium battery and a rechargeable lithium battery including the same, wherein the electrolyte solution includes a non-aqueous organic solvent, a lithium salt, a first additive and a second additive.

### CROSS-REFERENCE TO RELATED APPLICATION

This U.S. non-provisional patent application claims priority under 35 U.S.C. § 119 to Korean Patent Application No. 10-2024-0055505, filed on Apr. 25, 2024, the entire contents of which are hereby incorporated by reference.

### BACKGROUND

Examples of the present disclosure relate to an electrolyte solution for a rechargeable lithium battery, and to a rechargeable lithium battery including the electrolyte solution.

With increasing use of battery-using electronic devices, such as, e.g., mobile phones, laptop computers, electric vehicles, and the like, there is increasing demand for rechargeable batteries with high energy density and high capacity.

A rechargeable lithium battery typically includes a positive electrode, a negative electrode, and an electrolyte solution, wherein the positive electrode and the negative electrode each include an active material capable of intercalating and deintercalating lithium ions. The battery generates electrical energy by oxidation and reduction reactions when the lithium ions are intercalated/deintercalated into/from the positive electrode and the negative electrode.

A lithium salt may be dissolved in a non-aqueous organic solvent to constitute an electrolyte of the rechargeable lithium battery. The rechargeable lithium battery exhibits characteristics thereof by complex reactions between the positive electrode and the electrolyte, and between the negative electrode and the electrolyte. Thus, the use of an appropriate electrolyte is advantageous for improving performance of the rechargeable lithium battery.

### SUMMARY

The present disclosure includes an electrolyte solution for a rechargeable lithium battery, the electrode solution having improved lifetime characteristics and stability at high temperature.

The present disclosure also provides a rechargeable lithium battery including the electrolyte solution.

An example embodiment of the present disclosure includes an electrolyte solution for a rechargeable lithium battery, the electrolyte solution including a non-aqueous organic solvent; a lithium salt; a first additive represented by Chemical Formula 1; and a second additive represented by Chemical Formula 2:

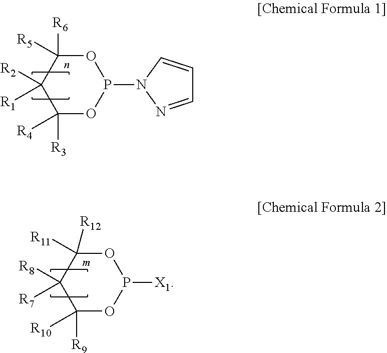

wherein, in Chemical Formula 1,
R₁ to R₆ are each independently hydrogen, an unsubstituted or substituted C1 to C20 alkyl group, an unsubstituted or substituted C1 to C20 alkoxy group, an unsubstituted or substituted C2 to C20 alkenyl group, an unsubstituted or substituted C2 to C20 alkynyl group, an unsubstituted or substituted C3 to C20 cycloalkyl group, an unsubstituted or substituted C6 to C20 aryl group, or an unsubstituted or substituted C2 to C20 heteroaryl group, and
n is an integer equal to 0 or 1,
wherein, in Chemical Formula 2,
X₁ is a fluoro group, a chloro group, a bromo group, or an iodo group,
R₇ to R₁₂ are each independently hydrogen, a cyano group, an unsubstituted or substituted C1 to C20 alkyl group, an unsubstituted or substituted C1 to C20 alkoxy group, an unsubstituted or substituted C2 to C20 alkenyl group, an unsubstituted or substituted C2 to C20 alkynyl group, an unsubstituted or substituted C3 to C20 cycloalkyl group, an unsubstituted or substituted C6 to C20 aryl group, or an unsubstituted or substituted C2 to C20 heteroaryl group, and
m is an integer equal to 0 or 1.

In an example embodiment of the present disclosure, a rechargeable lithium battery includes a positive electrode including a positive electrode active material; a negative electrode including a negative electrode active material; and an electrolyte solution, wherein the electrolyte solution includes a non-aqueous organic solvent; a lithium salt; the above-described first additive represented by Chemical Formula 1; and the above-described second additive represented by Chemical Formula 2.

### BRIEF DESCRIPTION OF DRAWINGS

The accompanying drawings are included to provide a further understanding of the present disclosure, and are incorporated in and constitute a part of this specification. The drawings illustrate example embodiments of the present disclosure and, together with the description, describe principles of the present disclosure. In the drawings:

FIG. 1 is a simplified conceptual view illustrating a rechargeable lithium battery, according to example embodiments of the present disclosure.

FIGS. 2 to 5 are cross-sectional views schematically illustrating a rechargeable lithium battery, according to an example embodiment.

### DETAILED DESCRIPTION OF EMBODIMENTS

In order to sufficiently understand the configuration and effect of the present disclosure, some example embodiments of the present disclosure will be described with reference to the accompanying drawings. It should be noted, however, that the present disclosure is not limited to the following example embodiments, and may be implemented in various forms. Rather, the example embodiments are provided only to disclose the present disclosure and let those skilled in the art fully know the scope of the present disclosure.

In this specification, it will be understood that, when an element is referred to as being “on” another element, the element can be directly on the other element or intervening elements may be present therebetween. In the drawings, thicknesses of some components are exaggerated for effectively explaining the technical contents. Like reference numerals refer to like elements throughout the specification.

Unless otherwise specially noted in this specification, the expression of singular form may include the expression of plural form. In addition, unless otherwise specially noted, the phrase “A or B” may indicate “A but not B,” “B but not A,” and “A and B.” The terms “comprises/includes” and/or “comprising/including” used in this specification do not exclude the presence or addition of one or more other components.

In this specification, “combination thereof” may refer to a mixture, a stack, a composite, a copolymer, an alloy, a blend, and a reaction product of components.

In this specification, unless otherwise defined, “substitution” means that at least one hydrogen in a substituent or compound is substituted with deuterium, a halogen group, a hydroxyl group, an amino group, a C1 to C30 amine group, a nitro group, a C1 to C40 silyl group, a C1 to C30 alkyl group, a C1 to C10 alkylsilyl group, a C6 to C30 arylsilyl group, a C3 to C30 cycloalkyl group, a C3 to C30 heterocycloalkyl group, a C6 to C30 aryl group, a C2 to C30 heteroaryl group, a C1 to C20 alkoxy group, a C1 to C10 fluoroalkyl group, a cyano group, or a combination thereof.

For example, the “substitution” may mean that at least one hydrogen in a substituent or compound is substituted with deuterium, a halogen group, a C1 to C30 alkyl group, a C1 to C10 alkylsilyl group, a C6 to C30 arylsilyl group, a C3 to C30 cycloalkyl group, a C3 to C30 heterocycloalkyl group, a C6 to C30 aryl group, a C2 to C30 heteroaryl group, a C1 to C10 fluoroalkyl group, or a cyano group. For example, the “substitution” may mean that at least one hydrogen in a substituent or compound is substituted with deuterium, a halogen group, a C1 to C20 alkyl group, a C6 to C30 aryl group, a C1 to C10 fluoroalkyl group, or a cyano group. Also, the “substitution” may mean that at least one hydrogen in a substituent or compound is substituted with deuterium, a halogen group, a C1 to C5 alkyl group, a C6 to C18 aryl group, a C1 to C5 fluoroalkyl group, or a cyano group. As an example, the “substitution” may mean that at least one hydrogen in a substituent or compound is substituted with deuterium, a cyano group, a halogen group, a methyl group, an ethyl group, a propyl group, a butyl group, a phenyl group, a biphenyl group, a terphenyl group, a trifluoromethyl group, or a naphthyl group.

When the terms “about” or “substantially” are used in this specification in connection with a numerical value, it is intended that the associated numerical value include a tolerance of ±10% around the stated numerical value. When ranges are specified, the range includes all values therebetween such as increments of 0.1%.

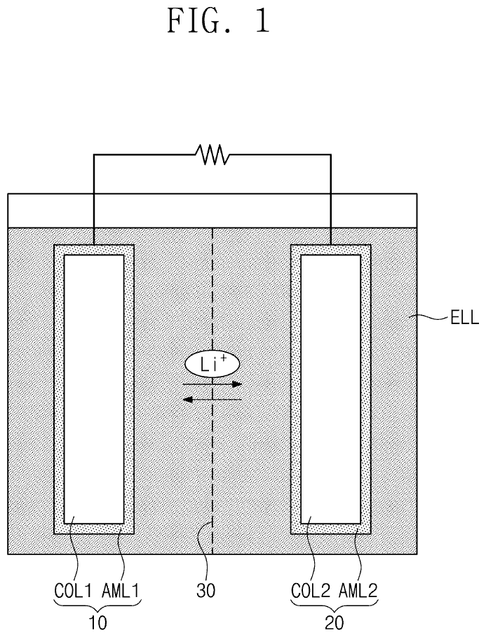

FIG. 1 is a cross-sectional view of a rechargeable lithium battery according to example embodiments of the present disclosure. Referring to FIG. 1, the rechargeable lithium battery may include a positive electrode 10, a negative electrode 20, a separator 30, and an electrolyte solution ELL.

The positive electrode 10 and the negative electrode 20 may be spaced apart from each other by the separator 30. The separator 30 may be disposed between the positive electrode 10 and the negative electrode 20. The positive electrode 10, the negative electrode 20 and the separator 30 may be in contact with the electrolyte solution ELL. The positive electrode 10, the negative electrode 20 and the separator 30 may be impregnated in the electrolyte solution ELL.

The electrolyte solution ELL may be or include a medium for transferring lithium ions between the positive electrode 10 and the negative electrode 20. In the electrolyte solution ELL, the lithium ions may move through the separator 30 toward the positive electrode 10 or the negative electrode 20.

### Positive Electrode 10

The positive electrode 10 for a rechargeable lithium battery may include a current collector COL1 and a positive electrode active material layer AML1 on the current collector. The positive electrode active material layer AML1 may include a positive electrode active material and may further include a binder and/or a conductive material (e.g., an electrically conductive material).

For example, the positive electrode 10 may further include an additive that can constitute a sacrificial positive electrode.

An amount of the positive electrode active material may be about 90 wt % to about 99.5 wt % based on 100 wt % of the positive electrode active material layer AML1. Amounts of the binder and the conductive material may be about 0.5 wt % to about 5 wt %, respectively, based on 100 wt % of the positive electrode active material layer AML1.

The binder is configured to attach the positive electrode active material particles to each other and also to attach the positive electrode active material to the current collector COL1. Examples of the binder may include at least one of polyvinyl alcohol, carboxymethyl cellulose, hydroxypropyl cellulose, diacetyl cellulose, polyvinylchloride, carboxylated polyvinylchloride, polyvinylfluoride, a polymer including ethylene oxide, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, nylon, and the like, as non-limiting examples.

The conductive material may impart conductivity (e.g., electrical conductivity) to the electrode. Any material that does not cause chemical change (e.g., that does not cause an undesirable chemical change in the rechargeable lithium battery), and that conducts electrons, can be used in the battery. Examples of the conductive material may include a carbon-based material such as at least one of natural graphite, artificial graphite, carbon black, acetylene black, ketjen black, a carbon fiber, a carbon nanofiber, and carbon nanotube; a metal-based material containing at least one of copper, nickel, aluminum, silver, etc., in a form of a metal powder or a metal fiber; a conductive polymer such as a polyphenylene derivative; or a mixture thereof.

The current collector COL1 may be or include Al, but is not limited thereto.

### Positive Electrode Active Material

The positive electrode active material may include a compound (lithiated intercalation compound) that is capable of intercalating and deintercalating lithium. For example, at least one of a composite oxide of lithium and a metal including at least one of cobalt, manganese, nickel, and combinations thereof may be used.

The composite oxide may be or include a lithium transition metal composite oxide. Examples of the composite oxide may include at least one of lithium nickel-based oxide, lithium cobalt-based oxide, lithium manganese-based oxide, lithium iron phosphate-based compound, cobalt-free nickel-manganese-based oxide, or a combination thereof.

As an example, the following compounds represented by any one or more of the following Chemical Formulas may be used. LiₐA_{1-b}X_{b}O_{2-c}D_{c} (0.90≤a≤1.8, 0≤b≤0.5, and 0≤c≤0.05); LiₐMn_{2-b}X_{b}O_{4-c}D_{c} (0.90≤a≤1.8, 0≤b≤0.5, and 0≤c≤0.05); LiₐNi_{1-b-c}Co_{b}X_{c}O_{2-α}D_{α} (0.90≤a≤1.8, 0≤b≤0.5, 0≤c≤0.5, and 0≤α≤2); LiₐNi_{1-b-c}Mn_{b}X_{c}O_{2-α}D_{α} (0.90≤a≤1.8, 0≤b≤0.5, 0≤c≤0.5, and 0<α<2); LiₐNi_{b}Co_{c}L¹_{d}GₑO₂ (0.90≤a≤1.8, 0≤b≤0.9, 0≤c≤0.5, 0≤d≤0.5, and 0≤e≤0.1); LiₐNiG_{b}O₂ (0.90≤a≤1.8 and 0.001≤b≤0.1); LiₐCoG_{b}O₂ (0.90≤a≤1.8 and 0.001≤b≤0.1); LiₐMn_{1-b}G_{b}O₂ (0.90≤a≤1.8 and 0.001≤b≤0.1); LiₐMn₂G_{b}O₄ (0.90≤a≤1.8 and 0.001≤b≤0.1); LiₐMn_{1-g}G_{g}PO₄ (0.90≤a≤1.8 and 0≤g≤0.5); Li_{(3-f)}Fe₂(PO₄)₃ (0≤f≤2); or LiₐFePO₄ (0.90≤a≤1.8).

In the above Chemical Formulas, A is or includes Ni, Co, Mn, or a combination thereof; X is or includes Al, Ni, Co, Mn, Cr, Fe, Mg, Sr, V, a rare earth element or a combination thereof; D is or includes O, F, S, P, or a combination thereof; G is or includes Al, Cr, Mn, Fe, Mg, La, Ce, Sr, V, or a combination thereof; and L¹ is or includes Mn, Al, or a combination thereof.

The positive electrode active material may be or include, for example, a high nickel-based positive electrode active material having a nickel content that is greater than or equal to about 80 mol %, greater than or equal to about 85 mol %, greater than or equal to about 90 mol %, greater than or equal to about 91 mol %, or greater than or equal to about 94 mol % and less than or equal to about 99 mol % based on 100 mol % of the metal excluding lithium in the lithium transition metal composite oxide. The high-nickel-based positive electrode active material may be capable of realizing high capacity and can be applied to a high-capacity, high-density rechargeable lithium battery.

### Negative Electrode 20

The negative electrode 20 for a rechargeable lithium battery may include a current collector COL2 and a negative electrode active material layer AML2 on the current collector COL2. The negative electrode active material layer AML2 may include a negative electrode active material, and may further include a binder and/or a conductive material (e.g., an electrically conductive material).

For example, the negative electrode active material layer AML2 may include about 90 wt % to about 99 wt % of the negative electrode active material, about 0.5 wt % to about 5 wt % of the binder, and about 0 wt % to about 5 wt % of the conductive material.

The binder may be configured to attach the negative electrode active material particles to each other and also to attach the negative electrode active material to the current collector COL2. The binder may include a non-aqueous binder, an aqueous binder, a dry binder, or a combination thereof.

The non-aqueous binder may include at least one of polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, poly amideimide, polyimide, or a combination thereof.

The aqueous binder may be or include at least one of a styrene-butadiene rubber, a (meth)acrylated styrene-butadiene rubber, a (meth)acrylonitrile-butadiene rubber, (meth)acrylic rubber, a butyl rubber, a fluoro rubber, polyethylene oxide, polyvinylpyrrolidone, polyepichlorohydrine, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resins, polyvinyl alcohol, and a combination thereof.

When an aqueous binder is the negative electrode binder, a cellulose-based compound capable of imparting viscosity may be further included. The cellulose-based compound may include at least one of carboxymethyl cellulose, hydroxypropylmethyl cellulose, methyl cellulose, or an alkali metal salt thereof. The alkali metal may include at least one of Na, K, or Li.

The dry binder may be a polymer material that is capable of being fibrous. For example, the dry binder may be or include at least one of polytetrafluoroethylene, polyvinylidene fluoride, a polyvinylidene fluoride-hexafluoropropylene copolymer, polyethylene oxide, or a combination thereof.

The conductive material may impart conductivity (e.g., electrical conductivity) to the electrode. Any material that does not cause chemical change (e.g., does not cause an undesirable chemical change in the rechargeable lithium battery), and that conducts electrons, can be used in the battery. Non-limiting examples thereof may include a carbon-based material such as at least one of natural graphite, artificial graphite, carbon black, acetylene black, ketjen black, a carbon fiber, a carbon nanofiber, and a carbon nanotube; a metal-based material including copper, nickel, aluminum, silver, etc. in a form of a metal powder or a metal fiber; a conductive polymer such as a polyphenylene derivative; or a mixture thereof.

The negative current collector COL2 may include at least one of a copper foil, a nickel foil, a stainless steel foil, a titanium foil, a nickel foam, a copper foam, a polymer substrate coated with a conductive metal, or a combination thereof.

### Negative Electrode Active Material

The negative electrode active material may include a material that reversibly intercalates/deintercalates at least lithium ions, a lithium metal, a lithium metal alloy, a material capable of doping/dedoping lithium, or a transition metal oxide.

The material that reversibly intercalates/deintercalates lithium ions may include a carbon-based negative electrode active material, such as, for example. at least one of crystalline carbon, amorphous carbon or a combination thereof. The crystalline carbon may be graphite such as non-shaped, sheet-shaped, flake-shaped, sphere-shaped, or fiber-shaped natural graphite or artificial graphite. The amorphous carbon may be or include at least one of a soft carbon, a hard carbon, a mesophase pitch carbonization product, calcined coke, and the like.

The lithium metal alloy includes an alloy of lithium and a metal including at least one of Na, K, Rb, Cs, Fr, Be, Mg, Ca, Sr, Si, Sb, Pb, In, Zn, Ba, Ra, Ge, Al, and Sn.

The material capable of doping/dedoping lithium may be or include a Si-based negative electrode active material or a Sn-based negative electrode active material. The Si-based negative electrode active material may include at least one of silicon, a silicon-carbon composite, SiOx (0<x<2), a Si-Q alloy (where Q includes at least one of an alkali metal, an alkaline-earth metal, a Group 13 element, a Group 14 element (excluding Si), a Group 15 element, a Group 16 element, a transition metal, a rare earth element, and a combination thereof). The Sn-based negative electrode active material may include Sn, SnO₂, a Sn-based alloy, or a combination thereof.

The silicon-carbon composite may be or include a composite of silicon and amorphous carbon. According to an example embodiment, the silicon-carbon composite may be in a form of silicon particles and amorphous carbon coated on the surface of the silicon particles. For example, the silicon-carbon composite may include a secondary particle (core) in which primary silicon particles are assembled, and an amorphous carbon coating layer (shell) on the surface of the secondary particle. The amorphous carbon may also be between the primary silicon particles, and, for example, the primary silicon particles may be coated with the amorphous carbon. The secondary particle may exist dispersed in an amorphous carbon matrix.

The silicon-carbon composite may further include crystalline carbon. For example, the silicon-carbon composite may include a core including crystalline carbon and silicon particles and an amorphous carbon coating layer on a surface of the core.

The Si-based negative electrode active material or the Sn-based negative electrode active material may be used in combination with a carbon-based negative electrode active material.

### Separator 30

Depending on the type of the rechargeable lithium battery, the separator 30 may be present between the positive electrode 10 and the negative electrode 20. The separator 30 may include at least one of polyethylene, polypropylene, polyvinylidene fluoride, or a multilayer film of two or more layers thereof, and a mixed multilayer film such as a polyethylene/polypropylene two-layer separator, polyethylene/polypropylene/polyethylene three-layer separator, polypropylene/polyethylene/polypropylene three-layer separator, and the like.

The separator 30 may include a porous substrate and a coating layer including an organic material, an inorganic material, or a combination thereof on one or both surfaces of the porous substrate.

The porous substrate may be or include a polymer film formed of or including any one polymer polyolefin including at least one of polyethylene and polypropylene, polyester such as polyethylene terephthalate and polybutylene terephthalate, polyacetal, polyamide, polyimide, polycarbonate, polyether ketone, polyarylether ketone, polyether ketone, polyetherimide, polyamideimide, polybenzimidazole, polyethersulfone, polyphenylene oxide, a cyclic olefin copolymer, polyphenylene sulfide, polyethylene naphthalate, a glass fiber, TEFLON, and polytetrafluoroethylene, or a copolymer or mixture of two or more thereof.

The organic material may include a polyvinylidene fluoride-based polymer or a (meth)acrylic polymer.

The inorganic material may include inorganic particles including at least one of Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof, but is not limited thereto.

The organic material and the inorganic material may be mixed in one coating layer, or a coating layer including an organic material and a coating layer including an inorganic material may be stacked.

### Electrolyte Solution ELL

The electrolyte solution ELL for a rechargeable lithium battery may include a non-aqueous organic solvent and a lithium salt.

The non-aqueous organic solvent may constitute a medium for transmitting ions taking part in the electrochemical reaction of a battery.

The non-aqueous organic solvent may be or include a carbonate-based, ester-based, ether-based, ketone-based, or alcohol-based solvent, an aprotic solvent, or a combination thereof.

The carbonate-based solvent may include at least one of dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like.

The ester-based solvent may include at least one of methyl acetate, ethyl acetate, n-propyl acetate, dimethyl acetate, methyl propionate, ethyl propionate, decanolide, mevalonolactone, valerolactone, caprolactone, and the like.

The ether-based solvent may include at least one of dibutyl ether, tetraglyme, diglyme, dimethoxyethane, 2-methyltetrahydrofuran, 2,5-dimethyltetrahydrofuran, tetrahydrofuran, and the like. In addition, the ketone-based solvent may include cyclohexanone, and the like. The alcohol-based solvent may include at least one of ethanol, isopropyl alcohol, and the like and the aprotic solvent may include nitriles such as R—CN (wherein R is a C2 to C20 linear, branched, or cyclic hydrocarbon group, a double bond, an aromatic ring, or an ether bond, and the like); amides such as dimethylformamide; dioxolanes such as 1,3-dioxolane, 1,4-dioxolane, and the like; sulfolanes, and the like.

The non-aqueous organic solvents may be used alone or in combination of two or more solvents.

In addition, when using a carbonate-based solvent, a cyclic carbonate and a chain carbonate may be mixed and used, and the cyclic carbonate and the chain carbonate may be mixed in a volume ratio of about 1:1 to about 1:9.

The lithium salt dissolved in the organic solvent supplies lithium ions in a battery, enables a basic operation of a rechargeable lithium battery, and improves transportation of the lithium ions between positive and negative electrodes. Examples of the lithium salt include at least one of LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide, LiFSI), LiC₄F₉SO₃, LiN(CₓF₂ₓ₊₁SO₂)(CyF_{2y+1}SO₂) (wherein x and y are integers of 1 to 20), lithium trifluoromethane sulfonate, lithium tetrafluoroethanesulfonate, lithium difluoro(oxalato)borate (LiDFOB), lithium difluorobis(oxalato)phosphate (LiDFBOP), and lithium bis(oxalato) borate (LiBOB).

### Rechargeable Lithium Battery

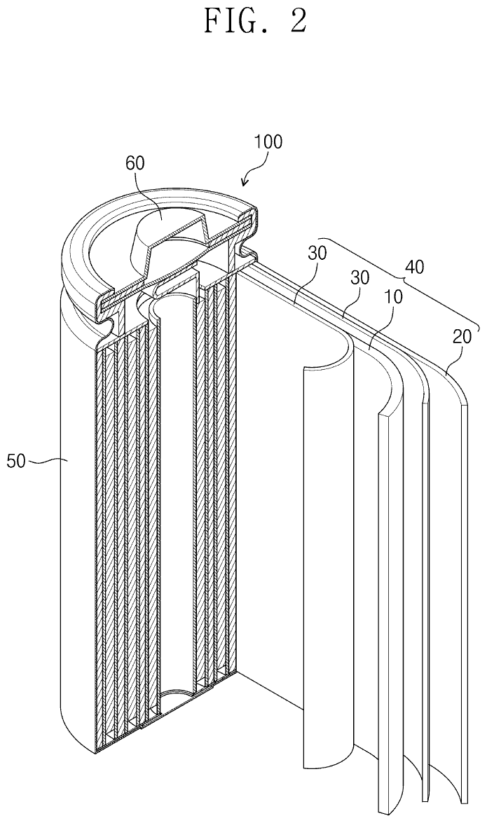

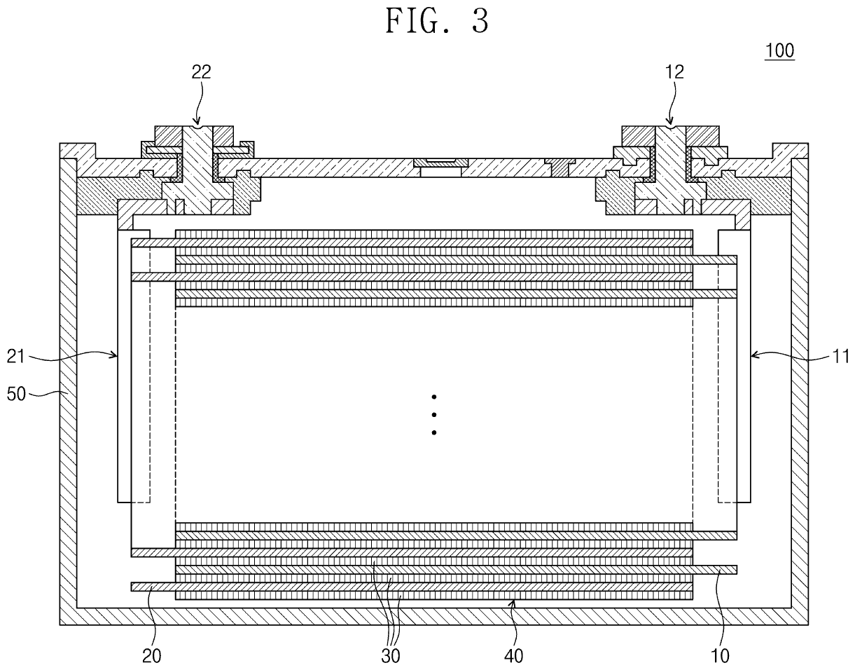

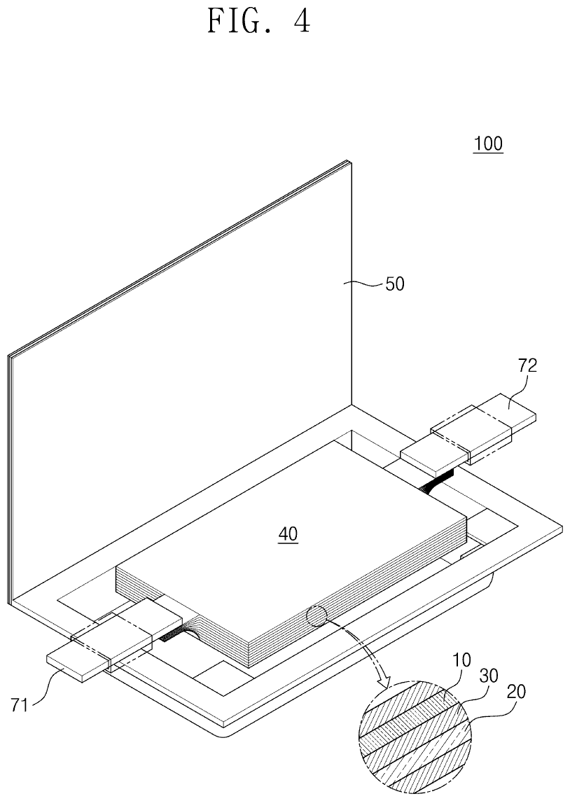

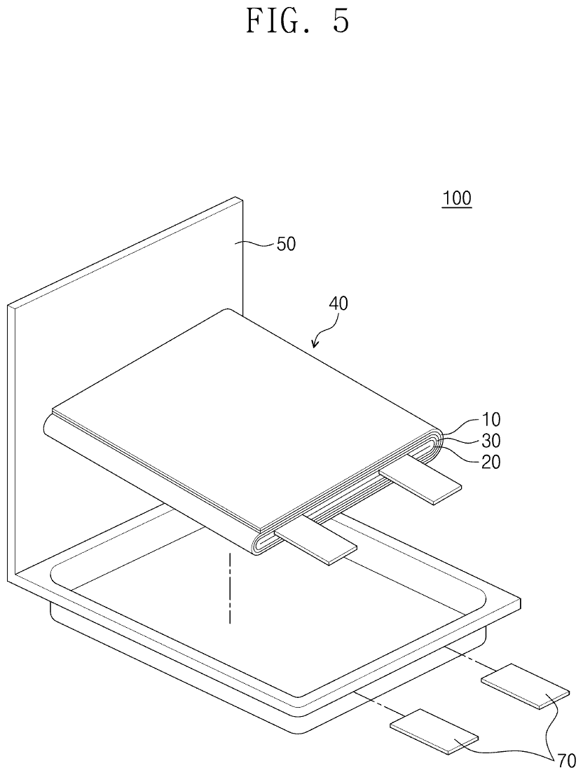

The rechargeable lithium battery may be classified into cylindrical, prismatic, pouch, or coin-type batteries, and the like depending on their shape. FIGS. 2 to 5 are schematic views illustrating a rechargeable lithium battery according to an example embodiment. FIG. 2 shows a cylindrical battery, FIG. 3 shows a prismatic battery, and FIGS. 4 and 5 show pouch-type batteries. Referring to FIGS. 2 to 5, the rechargeable lithium battery 100 may include an electrode assembly 40 including a separator 30 between a positive electrode 10 and a negative electrode 20, and a case 50 in which the electrode assembly 40 is included. The positive electrode 10, the negative electrode 20, and the separator 30 may be impregnated with an electrolyte solution (not shown). The rechargeable lithium battery 100 may include a sealing member 60 sealing the case 50, as shown in FIG. 2. In FIG. 3, the rechargeable lithium battery 100 may include a positive lead tab 11, a positive terminal 12, a negative lead tab 21, and a negative terminal 22. As shown in FIGS. 4 and 5, the rechargeable lithium battery 100 may include an electrode tab 70 illustrated in FIG. 5, which may be, for example, a positive electrode tab 71 and a negative electrode tab 72 illustrated in FIG. 4. The tabs 70/71/72 form an electrical path for inducing the current formed in the electrode assembly 40 to the outside of the battery 100.

Hereinafter, an electrolyte solution of a rechargeable lithium battery according to example embodiments of the present disclosure will be described in more detail.

An electrolyte solution for a rechargeable lithium battery according to an example embodiment may include at least one of a non-aqueous organic solvent; a lithium salt; a first additive represented by Chemical Formula 1 below which will be described later; and a second additive represented by Chemical Formula 2 below which will be described later.

The electrolyte solution may be prepared by a method through a mixing process in which a lithium salt is dissolved in a non-aqueous organic solvent, and the first additive and the second additive are added and mixed. The process of mixing the electrolyte solution is known in the field of electrolyte solution preparation, and a person skilled in the art will be able to appropriately select and use it.

The non-aqueous organic solvent may include at least one of ethylene carbonate (EC), propylene carbonate (PC), propyl propionate (PP), ethyl methyl carbonate (EMC), dimethyl carbonate (DMC), diethyl carbonate (DEC), dipropyl carbonate (DPC), methylpropyl carbonate (MPC), ethylpropyl carbonate (EPC), methylethyl carbonate (MEC), and butylene carbonate (BC).

In an example embodiment, the non-aqueous organic solvent may be or include a mixed solvent of ethylene carbonate (EC), ethyl methyl carbonate (EMC), and dimethyl carbonate (DMC).

As an example, the ethylene carbonate (EC) may be included in an amount of about 10 vol % to about 30 vol % based on a total amount of the non-aqueous organic solvent. The ethyl methyl carbonate (EMC) may be included in an amount of about 5 vol % to about 20 vol % based on the total amount of the non-aqueous organic solvent. The dimethyl carbonate (DMC) may be included in an amount of about 50 vol % to about 80 vol % based on the total amount of the non-aqueous organic solvent.

The lithium salt may include at least one of LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide (LiFSI)), and LiC₄F₉SO₃. According to an example embodiment, the lithium salt may be or include LiPF₆.

The lithium salt may have a concentration of about 0.1 M to about 2.0 M. For example, the lithium salt may have a concentration of about 0.5 M or more or about 1.0 M. The lithium salt may have a concentration of about 2.0 M or less, about 1.7 M or less, or about 1.5 M or less. In the present disclosure, when the lithium salt has a concentration of about 0.1 M to about 2.0 M, conductivity and viscosity of the electrolyte solution may be appropriately maintained.

### First Additive

The first additive according to the present disclosure may be represented by Chemical Formula 1 below:

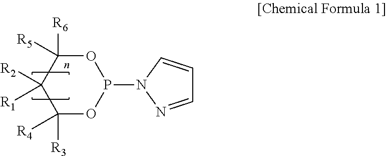

In Chemical Formula 1,
R₁ to R₆ may each independently be hydrogen, a cyano group, an unsubstituted or substituted C1 to C20 alkyl group, an unsubstituted or substituted C1 to C20 alkoxy group, an unsubstituted or substituted C2 to C20 alkenyl group, an unsubstituted or substituted C2 to C20 alkynyl group, an unsubstituted or substituted C3 to C20 cycloalkyl group, an unsubstituted or substituted C6 to C20 aryl group, or an unsubstituted or substituted C2 to C20 heteroaryl group.
n may be an integer equal to 0 or 1. When n is equal to 0, it may mean a direct bond. For example, in the case that n is equal to 0, a cyclic phospholane derivative moiety containing an —OPO— functional group may be a pentagonal ring.

In an example embodiment, Chemical Formula 1 may be represented by Chemical Formula 1A or 1B:

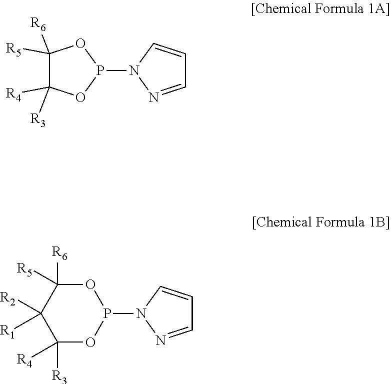

In Chemical Formula 1A and Chemical Formula 1B,
R₁ to R₆ may each independently be hydrogen, an unsubstituted or substituted C1 to C10 alkyl group, an unsubstituted or substituted C1 to C10 alkoxy group, an unsubstituted or substituted C2 to C10 alkenyl group, or an unsubstituted or substituted C2 to C10 alkynyl group.

In an example embodiment, R₃ and R₄ in Chemical Formula 1A may each be hydrogen, and
at least one of R₅ and R₆ may be an unsubstituted or substituted C1 to C10 alkyl group, an unsubstituted or substituted C1 to C10 alkoxy group, an unsubstituted or substituted C2 to C10 alkenyl group, or an unsubstituted or substituted C2 to C10 alkynyl group.

In an example embodiment, the first additive represented by Chemical Formula 1 may be or include at least one of the compounds listed in Group 1 below. That is, the first additive may be or include at least one of 1-(1,3,2-dioxaphospholan-2-yl)-1H-pyrazole and 1-(4-methyl-1,3,2-dioxaphospholan-2-yl)-1H-pyrazole):

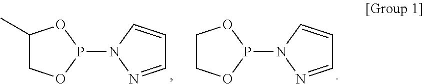

In an example embodiment, the first additive represented by Chemical Formula 1 may be or include a compound of Chemical Formula 1A-1 below:

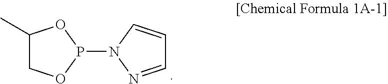

The first additive may be included in an amount of about 0.01 wt % to about 10 wt % based on a total amount of the electrolyte solution. For example, the amount of the first additive may be in a range of about 0.5 wt % to about 5 wt % based on the total amount of the electrolyte solution.

The amount of the additive may be the weight of the additive included in the electrolyte solution based on a total weight of the electrolyte solution. When the amount of the additive satisfies the above range, effects of reducing or suppressing an increase in resistance and reducing gas generation at high temperatures may be improved or maximized.

The first additive represented by Chemical Formula 1 may contain an —OPO— functional group. The —OPO— functional group may reduce the gas generation in the battery by stabilizing a thermal decomposition product of the lithium salt or anions dissociated from the lithium salt. For example, the —OPO— functional group may reduce HF gas generation by stabilizing PF₅⁻ generated when LiPF₆ is thermally decomposed.

The —OPO— functional group contained in the first additive may be derived from cyclic phospholane. The cyclic phospholane derivative may more significantly improve lifetime characteristics of the rechargeable lithium battery at high temperatures than a linear phosphite derivative. The linear phosphite derivative may not be suitable for high temperatures because the linear phosphite derivative causes gas generation due to a decomposition reaction of the electrolyte solution during high-temperature storage by inducing a side reaction of LiPF₆ due to a dissociated —PO₂— functional group.

The first additive may contain a pyrazole functional group. The pyrazole group is a compound with strong polarity, wherein, since the pyrazole functional group has high solubility in an electrolyte solution using a polar solvent such as ethylene carbonate, the pyrazole functional group may be advantageous for use as an additive in a rechargeable lithium battery.

In an example, lone pair electrons of nitrogen (N) in the pyrazole functional group may stabilize a Lewis acid (e.g., PF₅) by acting on the Lewis acid which may exist in the electrolyte solution. The stabilization of the Lewis acid reduces a continuous decomposition reaction of the lithium salt, and thus hinders or prevents the electrolyte solution from becoming an acidic environment. The lone pair electrons of the pyrazole group may also stabilize a transition metal on a surface of the positive electrode and a transition metal released from the surface of the positive electrode. This may improve lifetime of the battery by reducing or preventing degradation of the positive electrode.

The pyrazole group may be or include an amphoteric substance that may act as an acid or a base. Acidity of the pyrazole group may be derived from an —NH group, and may cause battery degradation. In the additive according to the present disclosure, the nitrogen (N) in the pyrazole group may be directly connected to phosphorus (P) through a covalent bond. In this case, since the —NH group of the pyrazole group is removed, only basicity of the pyrazole group may be used efficiently.

Since the first additive according to the example embodiments of the present disclosure simultaneously or contemporaneously contains the —OPO— functional group and the pyrazole functional group, the first additive may have a better effects of reducing or suppressing the increase in resistance and reducing gas.

An effect of improving high-temperature stability of the rechargeable lithium battery by the first additive represented by Chemical Formula 1 is more pronounced when the first additive is used together with a high-nickel-based positive electrode active material and a negative electrode active material including a silicon-carbon composite. For example, silicon particles may increase the capacity of the battery, but they may also increase the internal resistance of the battery by causing a side reaction with the electrolyte solution. Since the first additive reduces or suppresses the side reaction between the silicon particles and the electrolyte solution, the first additive may improve or maximize the increase of the capacity of the battery while reducing or minimizing the increase of the internal resistance of the battery.

### Second Additive

The second additive according to the present disclosure may be represented by Chemical Formula 2 below:

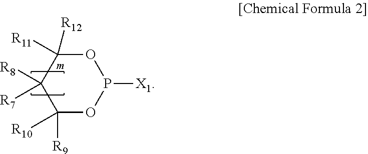

In Chemical Formula 2,
X₁ is a fluoro group, a chloro group, a bromo group, or an iodo group,
R₇ to R₁₂ are each independently hydrogen, a cyano group, an unsubstituted or substituted C1 to C20 alkyl group, an unsubstituted or substituted C1 to C20 alkoxy group, an unsubstituted or substituted C2 to C20 alkenyl group, an unsubstituted or substituted C2 to C20 alkynyl group, an unsubstituted or substituted C3 to C20 cycloalkyl group, an unsubstituted or substituted C6 to C20 aryl group, or an unsubstituted or substituted C2 to C20 heteroaryl group, and
m may be an integer equal to 0 or 1.
Chemical Formula 2 may be represented by Chemical Formula 2A or Chemical Formula 2B.

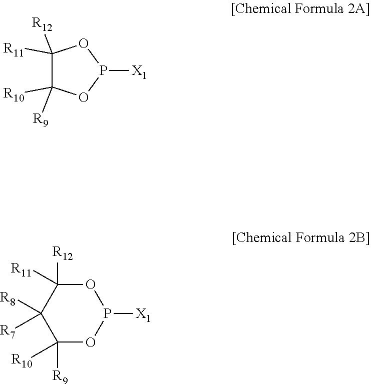

In Chemical Formulae 2A and 2B,
X₁ is a fluoro group, a chloro group, a bromo group, or an iodo group, and
R₇ to R₁₂ may each independently be hydrogen, an unsubstituted or substituted C1 to C10 alkyl group, an unsubstituted or substituted C1 to C10 alkoxy group, an unsubstituted or substituted C2 to C10 alkenyl group, or an unsubstituted or substituted C2 to C10 alkynyl group.

As an example, Chemical Formula 2 may be represented by Chemical Formula 2A. R₉ and R₁₀ in Chemical Formula 2A are each hydrogen, and at least one of R₁₁ and R₁₂ may be an unsubstituted or substituted C1 to C10 alkyl group. Also, R₉, R₁₀, R₁₁, and R₁₂ in Chemical Formula 2A may each be hydrogen.

As an example, the second additive represented by Chemical Formula 2 may be or include at least one of the compounds listed in Group 2 below, and, for example, may be or include at least one of 2-fluoro-1,3,2-dioxaphospholane and 2-fluoro-4-methyl-1,3,2-dioxaphospholane.

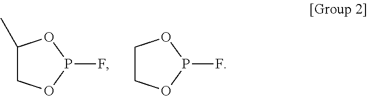

In an example embodiment, the second additive represented by Chemical Formula 2 may be a compound of Chemical Formula 2A-1 below:

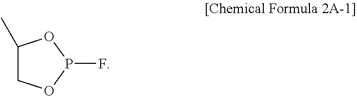

The second additive may be included in an amount of about 0.01 wt % to about 5 wt % based on the total amount of the electrolyte solution. For example, the amount of the second additive may be in a range of about 0.5 wt % to about 2 wt % based on the total amount of the electrolyte solution. In a case in which the amount range of the second additive is as described above, a rechargeable lithium battery with improved lifetime characteristics and output characteristics at high temperatures may be achieved.

The second additive forms a solid electrolyte interface (SEI) with high high-temperature stability and desired or improved ionic conductivity on a surface of the negative electrode, and may reduce the gas generation due to the decomposition reaction of the electrolyte solution during high-temperature storage by reducing or suppressing the side reaction of LiPF₆ due to the —PO₂F functional group.

For example, the second additive may form a composite by coordination with the thermal decomposition product of the lithium salt, such as LiPF₆, or the anions dissociated from the lithium salt. An unwanted side reaction between them and the electrolyte solution may be reduced or suppressed by stabilizing the thermal decomposition product of the lithium salt or the anions dissociated from the lithium salt due to the formation of the composite.

Accordingly, high-temperature storage characteristics may be significantly improved, and defect incident rate may be significantly reduced, by reducing or preventing the generation of gas in the rechargeable lithium battery in addition to improving cycle life characteristics of the rechargeable lithium battery.

A synergistic effect may occur when the first additive is used in combination with an additive having a structure containing the —PO₂F functional group (e.g., the above-described second additive). The combination of the first additive and the second additive not only may reduce or suppress the gas generation in the lithium battery and improve high-temperature storage performance of the battery, but also may improve high-temperature cycle and room-temperature cycle stabilities of the battery.

For example, since the electrolyte solution according to the present disclosure simultaneously or contemporaneously has the effect of reducing or suppressing the increase in the internal resistance of the battery by reducing or preventing the degradation of the positive electrode by the pyrazole group present in the first additive and the effect of reducing the gas generation by the —PO₂F functional group present in the second additive, it may be effective in improving the lifetime characteristics and stability under high-temperature conditions during activation of the rechargeable battery.

As an example, in the electrolyte solution, the amount of the first additive may be greater than the amount of the second additive. A ratio of the amount of the first additive to the amount of the second additive may be in a range of about 1 to about 10. According to an example embodiment, the amount ratio of the first additive to the second additive may be in a range of about 1 to about 6. In a case in which the amount ratio of the first additive to the second additive is less than the above range, the effect of reducing or suppressing the resistance at high temperature may be substantially insignificant, and, in a case in which the amount ratio of the first additive to the second additive is greater than the above range, lifetime efficiency of the rechargeable lithium battery may be rapidly reduced.

In another example embodiment of the present disclosure, a rechargeable lithium battery includes a positive electrode including a positive electrode active material; a negative electrode including a negative electrode active material; and an electrolyte solution, wherein the electrolyte solution includes a non-aqueous organic solvent; a lithium salt; the above-described first additive represented by Chemical Formula 1; and the above-described second additive represented by Chemical Formula 2.

The rechargeable lithium battery may be applicable to automobiles, mobile phones, and/or various types of electric devices, as non-limiting examples.

The positive electrode active material may include a lithium composite oxide represented by Chemical Formula 3 below.

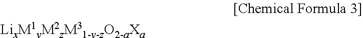

wherein 0.5≤x≤1.8, 0≤a≤0.05, 0<y≤1, 0≤z≤1, and 0≤y+z≤1,
M¹, M², and M³ may each independently include one or more elements metals including at least one of nickel (Ni), cobalt (Co), manganese (Mn), aluminum (Al), boron (B), barium (Ba), calcium (Ca), cerium (Ce), chromium (Cr), iron (Fe), molybdenum (Mo), niobium (Nb), silicon (Si), strontium (Sr), magnesium (Mg), titanium (Ti), vanadium (V), tungsten (W), zirconium (Zr), and lanthanum (La), and a combination thereof, and
X may include at least one of fluorine (F), sulfur (S), phosphorus (P), or chlorine (Cl).

In an example embodiment, in Chemical Formula 3, M¹ may be or include Ni, 0.8≤y≤1, and 0≤z≤0.2. Also, in Chemical Formula 3, M¹ may be or include Ni, M² may be Co, and M³ may be or include Al. Furthermore, in Chemical Formula 3, M¹ may be or include Ni, M² may be or include Co, and M³ may be or include Mn.

In an example embodiment, the positive electrode active material of the rechargeable lithium battery may include at least one of nickel, cobalt, and aluminum. Also, in an example embodiment, the positive electrode active material of the rechargeable lithium battery may include at least one of nickel, cobalt, and manganese.

A carbon-based negative electrode active material, a silicon-based negative electrode active material, or a combination thereof may constitute the negative electrode active material of the rechargeable lithium battery.

In an example embodiment, the silicon-based negative electrode active material may be or include a silicon-carbon composite.

The silicon-based negative electrode active material may include a core containing silicon-based particles, and a coating layer containing amorphous carbon. The silicon-based particles may include at least one of silicon particles, a Si—C composite, SiOₓ (0<x≤2), and a Si alloy.

In a case in which the positive electrode includes a high nickel-based positive electrode active material, and the negative electrode includes a silicon-carbon composite, the effect of improving the high-temperature stability of the rechargeable lithium battery may be improved or maximized. The rechargeable lithium battery of the above combination may operate at a high voltage of about 4.2 V or more.

The following Examples and Comparative Examples are provided in order to highlight characteristics of one or more example embodiments, but it will be understood that the Examples and Comparative Examples are not to be construed as limiting the scope of the example embodiments, nor are the Comparative Examples to be construed as being outside the scope of the example embodiments. Further, it will be understood that the example embodiments are not limited to the particular details described in the Examples and Comparative Examples.

### EXAMPLES AND COMPARATIVE EXAMPLES

### Example 1

### (1) Preparation of Electrolyte Solution

1.5 M LiPF₆ was dissolved in a non-aqueous organic solvent in which ethylene carbonate (EC), ethyl methyl carbonate (EMC), and dimethyl carbonate (DMC) were mixed in a volume ratio of about 20:10:70, and about 0.5 wt % of a first additive and about 0.5 wt % of a second additive were added to prepare an electrolyte solution.

The compound represented by Chemical Formula 2A-1 was used as the second additive:

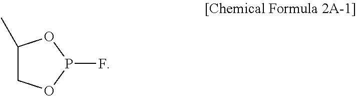

The compound represented by Chemical Formula 1A-1 was used as the first additive:

For example, the first additive according to Chemical Formula 1A-1 may be prepared from the following Synthesis Example.

### SYNTHESIS EXAMPLE

About 5.62 g (0.04 mol) of 2-chloro-4-methyl-1,3,2-dioxaphospholane was added dropwise into petroleum ether (40 mL), in which about 5.61 g (0.04 mol) of 1-(trimethylsilyl)-1H-pyrazole was dissolved, and stirred for about 10 minutes at room temperature (25° C.) in an inert atmosphere. After stirring for about 24 hours to evaporate volatile components of a reaction mixture, a residue was subjected to fractional distillation under a vacuum of about 3 Torr at about 77° C. to obtain the compound represented by Chemical Formula 1A-1:

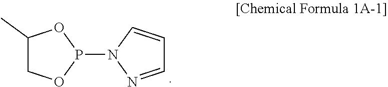

### (2) Fabrication of Rechargeable Lithium Battery

LiNi_{0.91}Co_{0.07}Al_{0.02}O₂ as a positive electrode active material, polyvinylidene fluoride as a binder, and ketjen black, as a conductive material, were mixed in a weight ratio of about 97:2:1 and dispersed in N-methyl pyrrolidone to prepare a positive electrode active material slurry.

The slurry was applied onto an about 14 μm thick aluminum current collector, dried at about 110° C., and subsequently pressed to prepare a positive electrode.

A mixture of artificial graphite and silicon nanoparticles in a weight ratio of about 93:7 as a negative electrode active material, a styrene-butadiene rubber (SBR) as a binder, and carboxymethyl cellulose (CMC), as a thickener, were mixed in a weight ratio of about 97:1:2 and dispersed in distilled water to prepare a negative electrode active material slurry.

The negative electrode active material slurry was applied onto an about 10 μm thick copper current collector, dried at about 100° C., and subsequently pressed to prepare a negative electrode.

An electrode assembly was prepared by assembling the positive electrode, the negative electrode, and an about 25 μm thick polyethylene separator, and the electrolyte solution was injected to fabricate a rechargeable lithium battery.

### Example 2

An electrolyte solution and a rechargeable lithium battery were prepared in the same manner as in Example 1 with a difference that about 1 wt % of the first additive was used.

### Example 3

An electrolyte solution and a rechargeable lithium battery were prepared in the same manner as in Example 1 with a difference that about 3 wt % of the first additive was used.

### Example 4

An electrolyte solution and a rechargeable lithium battery were prepared in the same manner as in Example 1 with a difference that about 5 wt % of the first additive and about 2 wt % of the second additive were used.

### Comparative Example 1

An electrolyte solution and a rechargeable lithium battery were prepared in the same manner as in Example 1 with a difference that the additive represented by Chemical Formula 1A-1 was not used during the preparation of the electrolyte solution.

### Comparative Example 2

An electrolyte solution and a rechargeable lithium battery were prepared in the same manner as in Example 1 with a difference that the first additive was not added during the preparation of the electrolyte solution.

### EVALUATION EXAMPLES

The rechargeable lithium batteries were evaluated in the following manner.

### Evaluation 1: Resistance Test

After the rechargeable lithium batteries fabricated in the examples and the comparative examples were charged to about 4.25 V at about 25° C., an initial resistance value of each battery and a resistance value after about 60 days at about 55° C. of each battery were respectively measured, a resistance increase rate was calculated, and the results thereof are presented in Table 1 below. Resistance was measured using electrochemical impedance spectroscopy (EIS).

A DC-IR measurement method was used to calculate the resistance value using current and voltage values which were obtained by discharging each battery at about 1 C for about 30 seconds at a state of charge (SOC 50).

The resistance increase rate was calculated according to Equation 1 below.

### [Equation 1]

$$Resistance increase rate ( \% ) = ( ( resistance value of the battery after 60 days / initial resistance value of the battery ) - 1 ) \times 100$$

### Evaluation 2: Evaluation of High-Temperature Gas Generation Characteristics

High-temperature gas generation characteristics were evaluated for the rechargeable lithium batteries according to the examples and the comparative examples. For this purpose, the rechargeable lithium batteries according to the examples and the comparative examples were charged to about 4.25 V at about 25° C. and subsequently left standing at about 55° C. for about 60 days.

An amount of gas generated from the cell battery while left standing for about 60 days was measured, and the results thereof are presented in Table 1 below.

TABLE 1

| | Resistance increase | Gas amount @60 |
|---|---|---|
| | rate @60 days | days during |
| | during high-temperature | high-temperature |
| | storage [%] | storage [ml] |
| Comparative | 21.9 | 39.8 |
| Example 1 | | |
| Comparative | 20.2 | 37.3 |
| Example 2 | | |
| Example 1 | 12.1 | 22.0 |
| Example 2 | 10.4 | 18.9 |
| Example 3 | 13.9 | 25.2 |
| Example 4 | 18.5 | 34.8 |

### Comprehensive Evaluation

Referring to Table 1, it may be confirmed that cases (Examples 1 to 4) of using the electrolyte solutions, in which the first and second additives according to the concept of the present disclosure were added, more effectively reduced or suppressed resistance and gas generation at high temperature (60° C.) than a case (Comparative Example 1) of using the electrolyte solution without any additives and a case (Comparative Example 2) of using only the second additive.

The electrolyte solution according to the example embodiment may exhibit the effect of improving the lifetime characteristics and stability under high-temperature conditions during the activation of the rechargeable battery by the combined use of the first additive containing a pyrazole group and the second additive containing a —PO₂F functional group.

Although example embodiments of the present disclosure have been described above, the scope of the present disclosure is not limited to the example embodiments. Various modifications of the example embodiments may be made without departing from the spirit and scope of the disclosure as defined by the appended claims, and the modifications are included in the scope of the present disclosure.

What is claimed is:

1. An electrolyte solution for a rechargeable lithium battery, the electrolyte solution comprising:
a non-aqueous organic solvent;
a lithium salt;
a first additive represented by Chemical Formula 1; and
a second additive represented by Chemical Formula 2: 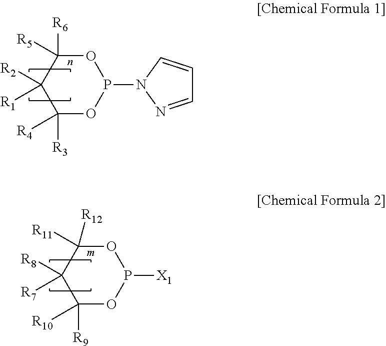
wherein, in Chemical Formula 1,
R₁ to R₆ are each independently hydrogen, an unsubstituted or substituted C1 to C20 alkyl group, an unsubstituted or substituted C1 to C20 alkoxy group, an unsubstituted or substituted C2 to C20 alkenyl group, an unsubstituted or substituted C2 to C20 alkynyl group, an unsubstituted or substituted C3 to C20 cycloalkyl group, an unsubstituted or substituted C6 to C20 aryl group, or an unsubstituted or substituted C2 to C20 heteroaryl group, and
n is an integer equal to 0 or 1,
wherein, in Chemical Formula 2,
X₁ comprises a fluoro group, a chloro group, a bromo group, or an iodo group,
R₇ to R₁₂ are each independently hydrogen, a cyano group, an unsubstituted or substituted C1 to C20 alkyl group, an unsubstituted or substituted C1 to C20 alkoxy group, an unsubstituted or substituted C2 to C20 alkenyl group, an unsubstituted or substituted C2 to C20 alkynyl group, an unsubstituted or substituted C3 to C20 cycloalkyl group, an unsubstituted or substituted C6 to C20 aryl group, or an unsubstituted or substituted C2 to C20 heteroaryl group, and
m is an integer equal to 0 or 1.

2. The electrolyte solution for a rechargeable lithium battery of claim 1, wherein Chemical Formula 1 is represented by Chemical Formula 1A or 1B: 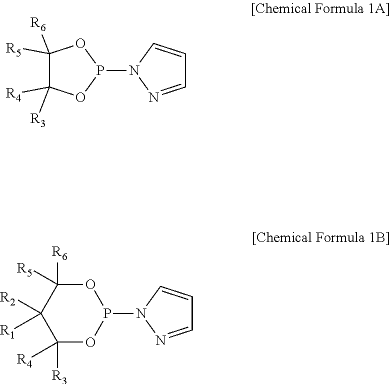
wherein, in Chemical Formula 1A and Chemical Formula 1B,
R₁ to R₆ are each independently hydrogen, an unsubstituted or substituted C1 to C10 alkyl group, an unsubstituted or substituted C1 to C10 alkoxy group, an unsubstituted or substituted C2 to C10 alkenyl group, or an unsubstituted or substituted C2 to C10 alkynyl group.

3. The electrolyte solution for a rechargeable lithium battery of claim 2, wherein R₃ and R₄ in Chemical Formula 1A are each hydrogen, and
at least one of R₅ and R₆ comprises an unsubstituted or substituted C1 to C10 alkyl group, an unsubstituted or substituted C1 to C10 alkoxy group, an unsubstituted or substituted C2 to C10 alkenyl group, or an unsubstituted or substituted C2 to C10 alkynyl group.

4. The electrolyte solution for a rechargeable lithium battery of claim 1, wherein the additive represented by Chemical Formula 1 comprises at least one of compounds listed in Group 1:

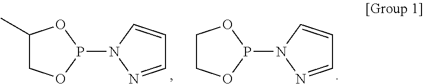

5. The electrolyte solution for a rechargeable lithium battery of claim 1, wherein Chemical Formula 2 is represented by Chemical Formula 2A or Chemical Formula 2B: 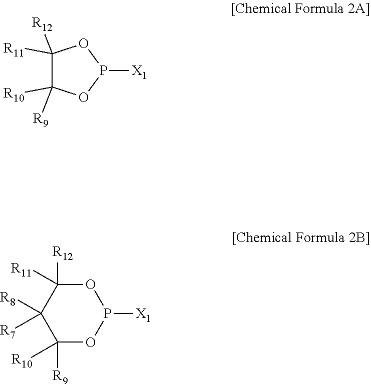
wherein, in Chemical Formulae 2A and 2B,
X₁ comprises a fluoro group, a chloro group, a bromo group, or an iodo group, and
R₇ to R₁₂ are each independently hydrogen, an unsubstituted or substituted C1 to C10 alkyl group, an unsubstituted or substituted C1 to C10 alkoxy group, an unsubstituted or substituted C2 to C10 alkenyl group, or an unsubstituted or substituted C2 to C10 alkynyl group.

6. The electrolyte solution for a rechargeable lithium battery of claim 5, wherein, in Chemical Formula 2A, R₉ and R₁₀ are each hydrogen, and at least one of R₁₁ and R₁₂ comprises an unsubstituted or substituted C1 to C10 alkyl group, an unsubstituted or substituted C1 to C10 alkoxy group, an unsubstituted or substituted C2 to C10 alkenyl group, or an unsubstituted or substituted C2 to C10 alkynyl group.

7. The electrolyte solution for a rechargeable lithium battery of claim 1, wherein the additive represented by Chemical Formula 2 comprises at least one of compounds listed in Group 2:

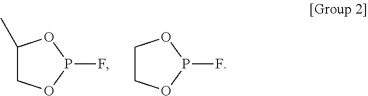

8. The electrolyte solution for a rechargeable lithium battery of claim 1, wherein an amount of the first additive is in a range of about 0.01 wt % to about 10 wt % based on a total weight of the electrolyte solution.

9. The electrolyte solution for a rechargeable lithium battery of claim 1, wherein an amount of the second additive is in a range of about 0.01 wt % to about 5 wt % based on a total weight of the electrolyte solution.

10. The electrolyte solution for a rechargeable lithium battery of claim 1, wherein an amount ratio of the first additive represented by Chemical Formula 1 to the second additive represented by Chemical Formula 2 is in a range of about 1 to about 6.

11. The electrolyte solution for a rechargeable lithium battery of claim 1, wherein the non-aqueous organic solvent comprises a carbonate-based solvent, and
the carbonate-based solvent comprises at least one of ethylene carbonate (EC), propylene carbonate (PC), propyl propionate (PP), ethyl methyl carbonate (EMC), dimethyl carbonate (DMC), diethyl carbonate (DEC), dipropyl carbonate (DPC), methylpropyl carbonate (MPC), ethylpropyl carbonate (EPC), methylethyl carbonate (MEC), and butylene carbonate (BC).

12. The electrolyte solution for a rechargeable lithium battery of claim 1, wherein the lithium salt comprises at least one of LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide (LiFSI)), and LiC₄F₉SO₃.

13. The electrolyte solution for a rechargeable lithium battery of claim 1, wherein the lithium salt has a concentration of about 0.1 M to about 2.0 M.

14. A rechargeable lithium battery comprising:
a positive electrode including a positive electrode active material;
a negative electrode including a negative electrode active material; and
the electrolyte solution of claim 1.

15. The rechargeable lithium battery of claim 14, wherein the positive electrode active material comprises a lithium composite oxide represented by Chemical Formula 3: 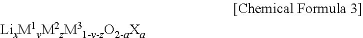
wherein 0.5≤x≤1.8, 0≤a≤0.05, 0<y≤1, 0≤z≤1, and 0≤y+z≤1,
M¹, M², and M³ each independently comprise one or more metals comprising at least one of nickel (Ni), cobalt (Co), manganese (Mn), aluminum (Al), boron (B), barium (Ba), calcium (Ca), cerium (Ce), chromium (Cr), iron (Fe), molybdenum (Mo), niobium (Nb), silicon (Si), strontium (Sr), magnesium (Mg), titanium (Ti), vanadium (V), tungsten (W), zirconium (Zr), and lanthanum (La), and
X comprises at least one of fluorine (F), sulfur (S), phosphorus (P), or chlorine (Cl).

16. The rechargeable lithium battery of claim 15, wherein, in Chemical Formula 3, M¹ comprises Ni, 0.8≤y≤1, and 0≤z≤0.2.

17. The rechargeable lithium battery of claim 14, wherein the negative electrode active material comprises at least one of a carbon-based negative electrode active material, and a silicon-based negative electrode active material.

18. The rechargeable lithium battery of claim 14, wherein the rechargeable lithium battery operates at a voltage of about 4.2 V or more.
